(19) United States
(12) Patent Application Publication
(10) Pub. No.: US 2021/0105069 A1
(43) Pub. Date: Apr. 8, 2021

(54) PROCESSING MULTIPLE CARRIER VISIBLE LIGHT COMMUNICATION SIGNALS

(71) Applicant: Nokia Technologies Oy, Espoo (FI)

(72) Inventors: Traian Abrudan, Dublin (IE); Stepan Kucera, Dublin (IE); Holger Claussen, Dublin (IE)

(73) Assignee: Nokia Technologies Oy, Espoo (FI)

(21) Appl. No.: 16/604,041

(22) PCT Filed: Apr. 13, 2017
(86) PCT No.: PCT/EP2017/059002

§ 371 Date: Oct. 9, 2019

(51) Int. Cl. H04B 10/116; H04L 27/26

(52) U.S. Cl. CPC H04B 10/116; H04L 27/2634

(57) ABSTRACT

Processing circuitry for processing data signal prior to transmitting said signal as a visible light communication signal is disclosed. The processing circuitry comprises: an input for receiving the data signal to be transmitted; mapping circuitry operable to map the data signal to a set of active subcarriers and to add nulls corresponding to inactive subcarriers to generate a mapped data signal. Transforming circuitry operable to apply a modified Fourier Transform operation to the mapped data signal to generate a transformed signal. The Fourier Transform operation being modified to maintain the nulls corresponding to the inactive subcarriers in the transformed signal, the transforming circuitry being operable to apply modified coefficients to at least some data values corresponding to active subcarriers to compensate for the maintained nulls, such that the modified Fourier Transform operation does not change the overall energy of the data signal.

### FIELD OF THE INVENTION

The invention relates to transmitting signals using visible light in some cases by modulating visible light sources used to illuminate a space.

### BACKGROUND

Emerging systems suggest employing visible-light communications (VLC) for transmitting data signals. In such systems the intensity of light sources, such as building lighting, is modulated to transmit the signals and this can currently achieve data rates of the order of Gigabits per second.

Orthogonal Frequency Division Multiplexing (OFDM) is currently the most promising technique for implementing physical and medium access layers of the emerging 5G mobile networking technologies. OFDM's main advantages include high spectral efficiency and inherent resilience against multi-path propagation, it does however, also pose a fundamental trade-off between:
achieving low Peak-to-Average Power Ratio (PAPR) of the transmitted OFDM signals in order to avoid signal distortion by power amplifiers with limited (linear) dynamic range;
enabling on-demand subcarrier blanking for flexible spectrum allocation and/or multi-user access based on frequency-domain multiplexing.

The above trade-off is well known to be difficult to balance in conventional OFDM-based radio-frequency (RF) wireless systems such as 4G LTE, future 5G mm-wave links, but it is even more challenging in the emerging systems employing visible light communications (VLC). The use of visible light as a carrier frequency imposes new additional constraints on the OFDM transceiver design which include:
Typical light sources such as light emission diodes (LEDs) or laser diodes exhibit very high nonlinearities that limit the signal dynamic range to a very small quasi-linear region. This region is even smaller than those of RF transceivers due to the unipolar nature of the intensity-modulated signal. High PAPR results in non-linear signal distortions that degrade the achievable error-free bit rate.
Unlike RF carriers, light bears no phase information, and therefore, the modulated VLC signal must be real-valued. To this end, Hermitian symmetry of the frequency domain symbols is typically imposed during the generation of the OFDM signal which reduces the spectral efficiency by half compared to complex-valued symbols.
Also specific to VLC, the output signal encodes the light intensity information, hence it must be non-negative. To this end, direct current (DC) biasing is used. Illumination level (dimming) may further reduce the dynamic range of the OFDM signal, thus high PAPR may result in signal clipping.
Finally, VLC communications also impose constraints on the signal spectrum. Due to DC biasing, the central OFDM subcarrier does not carry information. Depending on bandwidth and inter-carrier spacing, low-frequency subcarriers around DC may need to remain unmodulated (i.e., null subcarriers), in order to avoid disturbances such as low-frequency harmonics and slow signal fluctuations (DC-wander effects).

It would be desirable to provide encoding that allowed PAPR reduction and on-demand subcarrier nulling for flexible spectrum allocation, thus enabling multi-user access in OFDM signals.

### SUMMARY

A first aspect provides a method of processing a data signal prior to transmitting said signal as a visible light communication signal, said method comprising: receiving said data signal to be transmitted; mapping said data signal to a set of active subcarriers and adding nulls corresponding to inactive subcarriers to generate a mapped data signal; applying a modified Fourier Transform operation to said mapped data signal to generate a transformed signal, said Fourier Transform operation being modified to maintain said nulls corresponding to said inactive subcarriers in said transformed signal, and to apply modified coefficients to at least some data values corresponding to active subcarriers to compensate for said maintained nulls, such that said modified Fourier Transform operation does not change the overall energy of the data signal.

The inventors recognised that some schemes such as single carrier modulations automatically provide low PAPR, but that such schemes are not suitable for VLC communication as they have a DC component. VLC communications are subject to their light source varying by, for example being dimmed, and this makes DC components in the signal unreliable. Furthermore, imperfect electronics in such systems may also vary providing DC wander.

The present application provides a system using multiple carriers with certain selected carriers set to null values. These null values are preserved during Fourier Transform operations by using a modified Fourier Transform. In general a Fourier transform applied to a signal that contains some null values will mix up the signal values such that the null values are lost. In the current case, this mixing is suppressed by using a modified Fourier transform operation, this modified Fourier Transform is selected to preserve the nulls. The energy of the signal is preserved by modifying the coefficients of the Fourier transform operation that are applied to the input data that is not nulled. This may be achieved by increasing coefficient values in dependence on the amount that other values are decreased to preserve the nulls, so that the total magnitude of coefficients applied to the data values are maintained from the original Fourier Transform.

This technique provides both low PAPR and allows full data rate thereby removing some of the constraints of the prior art.

By providing multiple carriers, multiple access in the frequency domain is allowed.

In addition, the proposed approach has a very low complexity, which makes it easy to implement at high data rates.

In some embodiments, said transforming circuitry comprises: transforming circuitry operable to multiply said mapped data signal by a precoding matrix, said precoding matrix comprising a Fourier Transform matrix converted to form said precoding matrix, conversion of said Fourier Transform matrix comprising amending coefficients in contiguous regions determined by a location of said inactive subcarriers to nulls; and modifying values of coefficients in adjacent regions in dependence upon an original value of said coefficients amended to said null coefficients, such that a total magnitude of coefficient values of different regions in said matrix and said converted matrix is constant, thereby preserving a unitary property of said matrix.

Applying the modified Fourier transform operation to the mapped data signal may comprise multiplying the mapped data signal by a precoding matrix. The precoding matrix is formed by converting a Fourier transform matrix such that a modified Fourier Transform operation is performed on the signal. The conversion of the matrix involves amending coefficients in contiguous regions to nulls. The contiguous regions are determined by the location of the inactive subcarriers in the baseband spectrum. The values of coefficients in regions in the matrix adjacent to the location of the nulls are also modified. These values are modified in dependence upon an original value of the coefficients in the non-modified matrix that were amended to be the null coefficients. This is done such that a total magnitude of coefficient values of different regions in a matrix is the same in the converted or modified matrix as it was in the original Fourier Transform matrix, thereby preserving a unitary property of the matrix. In this regard, a total magnitude of all the coefficients in the matrix will be maintained between the converted and the original matrix as will the values in certain regions. Where a coefficient is amended to be a null value then other surrounding values which are not null values will be correspondingly increased in a way that preserves the unitary property of the matrix and in effect preserves the energy of the signal that is transformed.

A unitary matrix will provide a transform without noise colouring, such that noise covariance is preserved. Furthermore, it will conserve energy so that the transformed data signal and the mapped data signal have the same energy such that signal data is not lost due to this process.

In some embodiments, said precoding matrix is dependent upon a spectral mask applied to said data signal during said mapping step, said spectral mask determining said active and said inactive subcarriers.

A spectral mask is used to impose which subcarriers are null and the modified Fourier Transform or precoding matrix is generated to preserve the null subcarriers of the spectral mask after precoding. The spectral mask allows the selection of any subcarrier to be inactive, depending on desired properties of the coded signal.

As noted previously, the position of the nulls in the precoding matrix is related to the inactive subcarriers' locations. In effect, a spectral mask is applied to the broadband spectrum which applies nulls to some of the subcarriers, the shape of the spectral mask determining the subcarriers selected to be nulls. In some cases, the mask simply applies nulls to some subcarriers and leaves the others at their previous value such that a patterned matrix representing the spectral mask will be formed of ones and zeros. In other embodiments, the spectral mask may apply different amplitudes to different subcarriers, in which case there will be zero values representing the inactive subcarriers and there will be values between zero and one for the other active subcarriers.

In some embodiments, said precoding matrix comprises a matrix selected by matrix optimisation techniques to have a Frobenius norm of the difference between elements in the Fourier Transform matrix and the converted Fourier Transform matrix that is a minimum, whilst maintaining a unitary property of said matrix and having said contiguous regions of nulls.

The precoding matrix is as noted before a unitary matrix which property avoids noise colouring and preserves noise covariance. It also comprises the contiguous regions of nulls which allow the transformed signal to preserve the nulls rather than them being mixed across the subcarriers. In addition to this, the precoding matrix is selected by matrix optimisation techniques to have a Frobenius norm be as close as possible in Frobenius norm to the FFT matrix. It is the selection of a matrix with such a Frobenius norm that produces a modulated signal with a very low PAPR value.

In some embodiments, said set of inactive subcarriers comprise at least one subcarrier corresponding to zero frequency of a baseband spectrum and at least one edge of said baseband spectrum.

As noted previously, the provision of nulls that are maintained in the data signal as it is transformed allows selective subcarriers to be set to zero. Although this can be any selected subcarrier, in some cases it is the subcarrier corresponding to zero frequency of the baseband spectrum. This subcarrier relates to the DC value of the signal and thus, setting it to zero, alleviates any problems that might arise due to DC offset. Furthermore it may be advantage to set one or more subcarrier at at least one edge of the baseband spectrum to be inactive.

In this regard, as noted previously, DC offsets are a problem for visible light communication and thus being able to set the subcarrier corresponding to zero frequency to a null signal mitigates this problem. Furthermore, it may be desirable for the edge of the baseband spectrum to have inactive subcarriers. This may help with signal overlap from neighbouring spectra and also where the double sided baseband spectrum is such that it is not completely symmetrical around the zero frequency subcarrier, which will occur when the number of subcarriers is a factor of two, then the side with the additional carrier should have that edge carrier set to a null signal to avoid any problems that such a lack of symmetry may cause.

In some embodiments, the circuitry further comprises further transforming circuitry operable to apply an Inverse Fourier Transform operation to said transformed signal to generate a multi-carrier orthogonal frequency division multiplexed signal.

In order to generate the multi-carrier orthogonal frequency division multiplexed signal then the transformed signal has an Inverse Fourier Transform operation applied to it.

Although the modified Fourier Transform and the Inverse Fourier Transform operations may be performed by separate circuitry as separate steps, in some embodiments the Fourier Transform operation and Inverse Fourier Transform operation are applied as a single step by combined circuitry.

In some embodiments, the combined circuitry comprises circuitry operable to multiply the mapped data signal by a combined matrix, said combined matrix being generated by multiplying said modified Fourier Transform matrix (MFT) and said Inverse Fourier Transform matrix (IFT). In this regard, the order of multiplication is generally IFT.MFT.

In some embodiments, the circuitry further comprises cyclic prefix addition circuitry operable to add a cyclic prefix or a zero prefix to said multi-carrier orthogonal frequency division multiplex signal.

The addition of the cyclic prefix enables multipath effects to be compensated for. However, in some cases a zero prefix can be used instead.

In some embodiments, the processing circuitry further comprises serial to parallel conversion circuitry for converting a received data signal to form a plurality of parallel data signals; the parallel data signals being input to the mapping and transform circuitry; the processing circuitry further comprising parallel to serial converting circuitry to convert the plurality of parallel signals to a serial signal prior to output.

In some embodiments, said data signal comprises data signals received from a plurality of users, and said mapping circuitry is operable to map a data signal destined for one user to one set of active subcarriers and to map a data signal destined for at least one further user to at least one further set of active subcarriers.

The use of multiple carriers allows signals to multiple users to be transmitted by allocating different subsets of subcarriers to different users. In this way, receiving circuitry at a particular user can monitor the signals related to a particular subset of subcarriers. This selection of sets of subcarriers can be done in advance such that the circuitry is configured to select particular subsets for particular users and the receiving circuitry is aware of the subsets. Alternatively, it can be done in a configurable manner and control signals can be transmitted indicating which subsets have been selected for particular users.

A second aspect of the present invention provides processing circuitry operable to process a received visible light multi-carrier orthogonal frequency division multiplexed signal, said signal comprising low amplitude portions corresponding to inactive subcarriers, said processing circuitry comprising: transforming circuitry operable to apply a Fourier Transform operation to said received signal to generate a transformed signal; further transforming circuitry operable to apply a modified Inverse Fourier Transform operation to said transformed signal to generate a data signal, said modified Inverse Fourier Transform operation converting said low amplitude portions of said received signal corresponding to said inactive subcarriers to null signals and applying modified coefficients to at least some values corresponding to active subcarriers, said modified coefficients being such that said modified Inverse Fourier Transform operation does not change an overall energy of said data signal.

Decoding of the signal modulated according to an embodiment, involves the steps in the coding of the signal being reversed such that it is the Inverse Fourier Transform that is modified.

In some embodiments, said further processing circuitry is configured to: multiply said data signal by a Hermitian transpose of a precoding matrix, said precoding matrix comprising a converted Fourier Transform matrix, conversion of said Fourier Transform matrix comprising: null coefficients in contiguous regions determined by a location of said inactive subcarriers; and coefficients in adjacent regions amended such that a total magnitude of coefficient values of different regions in said matrix and said converted matrix is constant, thereby preserving a unitary property of said matrix.

The reversing of the steps may involve taking the Hermitian transpose of the matrices used in the coding steps. So that there is a Hermitian transpose of the original Inverse Fourier Transform matrix which provides a Fourier Transform operation, and the Hermitian transpose of the modified Fourier Transform matrix, which provides the modified Inverse Fourier Transform matrix.

In some embodiments, equalization circuitry is arranged between said transforming and said further transforming circuitry operable to perform equalization of said received signals to compensate for different channel losses.

Although where there are perhaps not many multipath channel effects, then an equalization operation between applying the Fourier Transform operation and the modified Inverse Fourier Transform operation may not be required. However, in cases where different channel losses vary considerably, then such equalization is advantageous.

In some embodiments, the processing circuitry further comprises separating circuitry configured to separate signals according to sets of subcarriers, signals from one set of subcarriers corresponding to signals from one user, and signals from at least one further set of subcarriers corresponding to signals from at least one further user.

A third aspect provides, a method of processing a data signal prior to transmitting said signal as a visible light communication signal, said method comprising: receiving said data signal to be transmitted mapping said data signal to a set of active subcarriers and adding nulls corresponding to inactive subcarriers to generate a mapped data signal; applying a modified Fourier Transform operation to said mapped data signal to generate a transformed signal, said Fourier Transform operation being modified to maintain said nulls corresponding to said inactive subcarriers in said transformed signal, and to apply modified coefficients to at least some data values corresponding to active subcarriers to compensate for said maintained nulls, such that said modified Fourier Transform operation does not change the overall energy of the data signal.

In some embodiments, said step of applying said modified Fourier Transform operation comprises: multiplying said mapped data signal by a precoding matrix, said precoding matrix comprising a Fourier Transform matrix converted to form said precoding matrix, by amending coefficients in contiguous regions determined by a location of said inactive subcarriers to nulls; and modifying values of coefficients in adjacent regions in dependence upon an original value of said coefficients amended to said null coefficients, such that a total magnitude of coefficient values of different regions in said matrix and said converted matrix is constant, thereby preserving a unitary property of said matrix.

In some embodiments, said precoding matrix is dependent upon a spectral mask applied to said data signal during said mapping step, said spectral mask determining said active and said inactive subcarriers.

In some embodiments, said precoding matrix is a patterned matrix, comprising regions of null and non-null values arranged in a pattern of alternating regions, said pattern being dependent on said spectral mask.

In some embodiments, said precoding matrix comprises a matrix selected by matrix optimisation techniques to have a Frobenius norm of the difference between elements in the Fourier Transform matrix and the converted Fourier Transform matrix that is a minimum whilst maintaining a unitary property and comprising said contiguous regions of nulls.

In some embodiments, said set of inactive subcarriers comprise at least one subcarrier corresponding to zero frequency of a baseband spectrum and at least one at a lower edge of said baseband spectrum.

In some embodiments, the method comprises a further step of applying an inverse Fourier Transform operation to said transformed signal to generate a multi-carrier orthogonal frequency division multiplexed signal.

In some embodiments, said step of applying said step modified Fourier Transform operation and said further step of applying an inverse Fourier Transform operation are performed as a single step.

In some embodiments, said single step comprises multiplying said mapped data signal by a combined matrix, said combined matrix being generated by multiplying said modified Fourier Transform matrix and said inverse Fourier Transform matrix.

In some embodiments, said method further comprises adding a cyclic prefix or a zero prefix to said multi-carrier orthogonal frequency division multiplexed signal.

Acyclic prefix is helpful for dealing with multipath channels, but a zero prefix can be used instead.

In some embodiments, the method further comprises: an initial step of performing serial to parallel conversion of said received data signal to form a plurality of parallel data signals; said subsequent steps, prior to said transmitting step being performed on said plurality of parallel data signals; and prior to transmitting said visible light communication signal performing a parallel to serial conversion of said plurality of parallel signals.

In some embodiments, said data signal comprises data signals received from a plurality of users, and said mapping step comprises mapping a data signal destined for one user to one set of active subcarriers and mapping a data signal destined for at least one further user to at least one further set of active subcarriers.

A fourth aspect provides a method of processing a received visible light multi-carrier orthogonal frequency division multiplexed signal, said signal comprising low amplitude portions corresponding to inactive subcarriers comprising: applying a Fourier Transform operation to said received signal to generate a transformed signal; applying a modified inverse Fourier Transform operation to said transformed signal to generate a data signal, said modified inverse Fourier Transform operation converting said low amplitude portions of said received signal corresponding to said inactive subcarriers to null signals and applying modified coefficients to at least some values corresponding to active subcarriers, said modified coefficients being such that said modified inverse Fourier Transform operation does not change an overall energy of said data signal.

In some embodiments, said step of applying said modified inverse Fourier Transform operation comprises: multiplying said data signal by a Hermitian transpose of a precoding matrix, said precoding matrix comprising a converted Fourier Transform matrix, said converted Fourier Transform matrix comprising: null coefficients in contiguous regions determined by a location of said inactive subcarriers; and coefficients in adjacent regions amended such that a total magnitude of coefficient values of different regions in said matrix and said converted matrix is constant, thereby preserving a unitary property of said matrix.

In some embodiments, the method comprise between said step of applying said Fourier Transform operation and said modified Inverse Fourier Transform Operation, performing an equalization step to compensate for different channel losses.

In some embodiments, the method comprises separating signals according to sets of subcarriers, signals from one set of subcarriers corresponding to signals from one user, and signals from at least one further set of subcarriers corresponding to signals from at least one further user.

A fifth aspect provides a computer program which when executed by a processor is operable to control said processor to perform said method of a third or fourth aspect.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIG. 1 illustrates Improvement of PAPR CCDF of the proposed UCP-OFDM vs. state-of-the-art U-OFDM for different constellations;

FIG. 2 shows a linear precoder according to an embodiment inserted in the conventional OFDM transmitter chain in order to ensure low PAPR and controlled subcarrier blanking;

FIG. 3 shows the energy transformation concept in the proposed UCP-OFDM precoding matrix;

FIG. 4 shows a block diagram of a transmitter chain containing the UCP-OFDM precoder according to an embodiment;

FIG. 5 shows an illustration of active/null subcarrier spectral mask;

FIG. 6 shows a checkerboard-like heat map of the binary spectral mask matrix;

FIG. 7 shows a heat map of magnitude and angle of the elements of the UCP-OFDM precoding matrix W according to an embodiment;

FIG. 8 shows a block diagram illustrating a decoder corresponding to the precoder of FIG. 2;

FIG. 9 shows an eye diagram of the oversampled time-domain UCP-OFDM signal; and

FIG. 10 shows the amplitude spectrum of the proposed UCP-OFDM signal, where the five null subcarriers centered at zero frequency and the one null subcarrier at the edge of the spectrum are clearly visible.

### DESCRIPTION OF THE EMBODIMENTS

Before discussing the embodiments in any more detail, first an overview will be provided.

Embodiments seek to provide full data throughout while permitting on-demand subcarrier nulling and low PAPR.

Conventionally, PAPR reduction in VLC systems is based either on ad hoc modifications of originally RF-oriented solutions, or they target VLC-specific design. However, as explained in more detail below, all of the current solutions have some drawbacks and fail to satisfy all of the above-mentioned constraints simultaneously, and/or are not practically usable due to other issues such as high complexity, noise sensitivity, or DC wander effects.

RF-Inspired Solutions

Data-dependent redundant precoding and null subcarriers shuffling can reduce PAPR, but it degrades throughput by relying on redundancy, and/or require intensive real-time computations.

Precoding based on Zadoff-Chu orthogonal sequences achieves very low PAPR but cannot produce real-valued signals, nor provide control over null subcarriers.

VLC-Specific Solutions

DC-Offset OFDM (DC-OFDM), rather than reducing the high PAPR level of the OFDM signal, it optimizes the DC bias value in order to minimize the signal clipping. This results in a very narrow dynamic range. Clipping distorts the transmitted signal considerably by inter-modulation, and therefore, it requires very complex nonlinear equalizers such as Volterra filters. Consequently, the desirable frequency-domain single-tap equalization feature of OFDM is lost.

Asymmetrically Clipped Optical OFDM (ACO-OFDM) uses a zero DC bias value to obtain positive time-domain signal. Negative samples are all set to zero, and only odd subcarriers are modulated. This way, most clipping noise becomes orthogonal to the desired signal, i.e., it appears on even subcarriers. However, due to halving the number of active subcarriers, the spectral efficiency is further reduced by half.

Discrete Hartley Transform (DHT) modulation has been proposed to achieve lower PAPR. When a real-valued constellation is used, the method produces a real-valued signal. However, since it involves the asymmetric clipping procedure used in ACO-OFDM, it also reduces the spectral efficiency by half.

Carrier-less Amplitude Modulation method (CAP) involves a pair of Hilbert filters that produce two time-domain orthogonal sequences corresponding to the in-phase and quadrature signals. However, CAP does not benefit from the great advantages of OFDM in dealing with multipath (single-tap equalization), and require a very complex time-domain equalizer.

Single carrier (SC) modulation with frequency-domain equalization (FDE) possesses very low PAPR. For example, the FFT-precoded OFDM is used for uplink in the 4th Generation (4G) Long Term Evolution (LTE) wireless communication standard in order to achieve high energy efficiency and lower cost of the power amplifier at the mobile device. However, SC-FDE does not allow on demand subcarrier nulling. Moreover, when pulse amplitude modulation (PAM) is employed, it is affected by DC-wander effects. This limits its use to low-order modulations only, hence it achieves low spectral efficiency. In order to circumvent this issue up-conversion may be employed, which requires additional stable carrier oscillators and filters, thus increasing the transceiver complexity.

Unipolar-OFDM (U-OFDM) technique is the current state-of the art modulation for VLC. It achieves a positive time-domain signal by repeating the bipolar OFDM signal samples twice, multiplying the second half by −1, and then setting all negative samples to zero. This way, no biasing is required, and clipping is asymmetrical. However, as a consequence of the OFDM symbol length doubling, the spectral efficiency is reduced by half, as it is for ACO-OFDM. Additional spectral efficiency reduction is caused by the fact that both positive and negative halves require separate cyclic prefixes.

Enhanced Unipolar OFDM (eU-OFDM) has been recently proposed. It seeks to compensate for the spectral efficiency loss of U-OFDM by superimposing several unipolar streams. However, full rate is never actually achieved in practice, since that would require an infinite number of superimposed streams. Moreover, decoding employs very complex successive interference cancellation, i.e., the decoded streams need to be re-encoded to perform interference subtraction. Furthermore, processing is applied to very large data blocks whose length increases exponentially (powers of two) with the number of superimposed streams. And, finally, eU-OFDM suffers from error propagation between subsequent decoding stages. The only enhancement of eU-OFDM over U-OFDM is that it partly compensates for the throughout loss, but PAPR is actually worse due to the stream superposition. For this reason, the original U-OFDM is used as a base of comparison in terms of PAPR for embodiments of the technique of this application.

Embodiments seek to provide both full data rate (high spectral efficiency) and low PAPR by using plural subcarriers and using pre-coding to null selected subcarriers. This can be used to remove DC components by selecting the subcarriers at or at and close to zero frequency. To perform OFDM of the signal a Fourier Transform and Inverse Fourier Transform are performed on the multi-carrier signal. Performing the Fourier transform operation mixes up the subcarriers so a modified Fourier Transform operation is performed which preserves the nulls in the signal. This involves setting regions of the Fourier Transform matrix to zero. In order to maintain full data and preserve noise covariance the unitary nature of this matrix should be preserved and thus, coefficients in regions adjacent to the zero regions are increased so that the total magnitude of coefficients in different regions and in the whole matrix are maintained. In this way a transform is performed that provides nulls in selected subcarriers while preserving low PAPR.

Having a plurality of subcarriers allows multiple users access in the frequency domain, signals to different users being transmitted on different subsets of subcarriers.

Proposed Embodiments Termed—Unitary Checkerboard Precoded OFDM (UCP-OFDM) Compared to the State-of-the-Art Solution

In the text below it is demonstrated that the proposed UCP-OFDM scheme achieves 3-5 dB PAPR reduction compared to state-of-the-art U-OFDM, when the number of subcarriers is relatively small (<256). This performance improvement increases further when a larger number of subcarriers is used. In addition, the proposed UCP-OFDM scheme achieves double throughput compared to U-OFDM, ACO-OFDM and DHT modulations, subject to similar computational complexity.

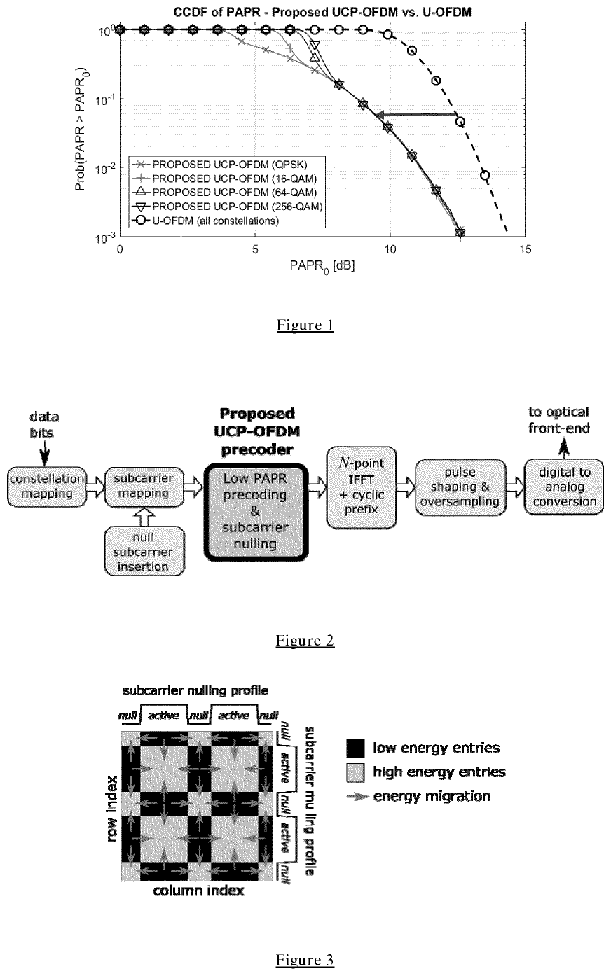

In FIG. 1, the proposed UCP-OFDM scheme is compared to the state-of-the-art U-OFDM. A multicarrier VLC transmission with 256 subcarriers of which 250 are active is considered. There are 2 null subcarriers on each side of the DC subcarrier (which is also null), and one null subcarrier at the lower edge of the spectrum. The PAPR after pulse shaping and oversampling is analysed, with these processes being performed by using a poly-phase root-raised cosine filter with oversampling ratio of 8, roll-off factor 0.5, and group delay of 8 samples at the lower rate. Different input constellations: BPSK, QPSK, 16-QAM, 64-QAM and 256-QAM are considered.

The PAPR complementary cumulative distribution function (CCDF) of the pulse-shaped time-domain signals is shown in FIG. 1. FIG. 1 shows that the proposed UCP-OFDM achieves a reduction in PAPR of 3-5 dB compared to the state-of-the-art U-OFDM. Actually, the PAPR of the proposed UCP-OFDM signal is just about 1-2 dB larger than the one corresponding to a single carrier signal (assuming the same constellation type). In addition, the proposed UCP-OFDM achieves double spectral efficiency compared to U-OFDM.

Thus, FIG. 1 shows the PAPR comparison of the different schemes using complementary cumulative distribution function (CCDF) and considering different input constellations. In conclusion, the proposed scheme outperforms state-of-the-art schemes by several dBs in terms of PAPR reduction, and up to 50% in spectral efficiency.

Embodiments achieve simultaneously two goals in OFDM transceiver design, namely
ultra-low PAPR of the transmitted OFDM signal (levels close to the performance of single carrier modulation, but no up/down-conversion are required)
full control over the presence of null subcarriers, regardless of their location and purpose (such as elimination of DC-wander effects and multi-user access across subcarriers).

These goals are achieved by inserting a linear precoding module before the Inverse Fast Fourier Transform (IFFT) operation at the transmitter, as illustrated in FIG. 2.

The proposed precoding matrix stems from the Fast Fourier Transform (FFT) matrix used in OFDM, which is modified by nulling certain contiguous regions, while preserving its unitary property. The resulting matrix exhibits a checkerboard-like pattern, as shown in FIG. 3 with alternating regions of zero and non-zero coefficients. For this reason, we call the proposed precoding method “Unitary Checkerboard Precoded OFDM”, henceforth simply abbreviated as UCP-OFDM.

The idea is to combine an FFT-like precoding with the IFFT-based operation in the OFDM transmission chain such that the resulting matrix is a unitary matrix which is close to the identity matrix. This way, the PAPR of the resulting OFDM signal is reduced to near the level achievable by single carrier transmission (unmodulated frequency-domain symbols), while preserving the locations of the null subcarriers.

FIG. 2 shows a block diagram schematically illustrating the coding process. Data to be encoded is received and an input constellation mapping is performed on the data and the resultant signal is mapped to the subcarriers in the baseband spectrum. This mapping includes the insertion of null subcarriers, which are the inactive subcarriers that are selected depending on the desired properties. Thus, they may relate to zero frequency in the baseband and to edge positions of the baseband spectrum. The precoding of the signal is then performed which involves a modified Fourier Transform operation that preserves the inserted nulls and the overall energy of the signal. An Inverse Fourier Transform is then performed and the signal is converted to an analogue signal and used to modulate a visible light source.

FIG. 3 shows the energy transformation concept in the proposed UCP-OFDM modified Fourier Transform Operation which is performed by multiplying the signals by a precoding matrix. The precoding matrix is formed of regions of nulls and regions of non-zero coefficients. Energy is extracted from certain rectangular regions in order to preserve the locations of the null subcarriers, while keeping the overall energy. The result is a checkerboard-like matrix;

More specifically, the proposed UCP-OFDM transforms the FFT matrix by acting on the magnitude of several entries that are grouped in rectangular regions (see FIG. 3). The energy is redistributed among these rectangular regions of the matrix while preserving the total energy. FIG. 3 illustrates the energy transformation concept by visualizing the heat map of the proposed precoding matrix. This is characterized by zero entries in areas required to preserve the location of null subcarriers (shown in black color), according to a user-defined subcarrier nulling profile.

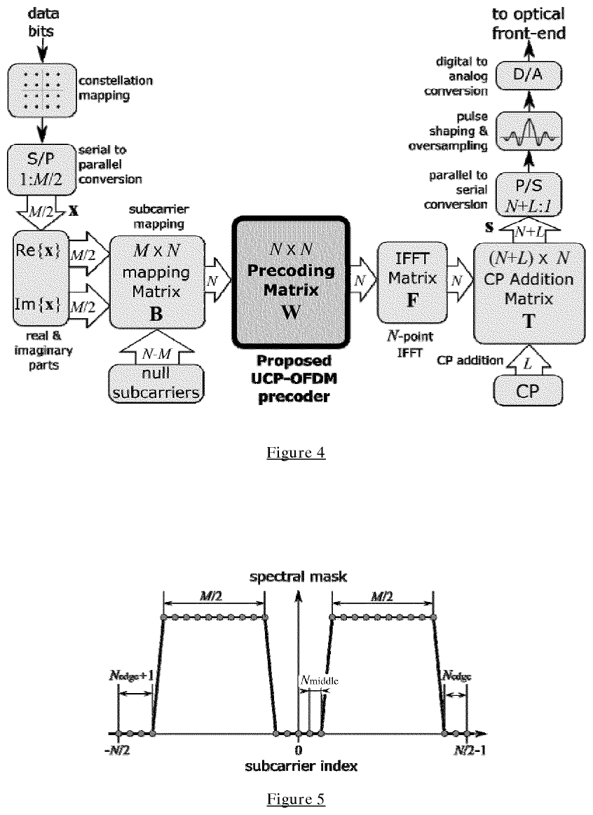

The invention assumes a multicarrier transmission with A subcarriers of which M are active (hence there are N−M null subcarriers). A coded data bit stream is sequentially mapped to blocks of complex-valued constellation points represented by an M/2×1 column vector x. The real and imaginary parts of x are then used to construct an M×1 real-valued vector (which essentially consists of PAM levels) to be sent across M active subcarriers. N−M zeros corresponding to the null subcarriers are then inserted to form an N×1 vector which is the input of the proposed precoder (the highlighted block in FIG. 4). After precoding, the usual IFFT operation is performed, followed by adding a cyclic prefix (CP) of length L. The signal is then serialized, oversampled and pulse-shaped, and then converted to an analogue waveform for the optical front-end. Then, DC biasing, pre-equalization and amplification are performed before the signal is converted to modulate visible light.

Proposed Precoder

Let us define the binary active/null subcarrier spectral mask in as an N×1 vector whose entries are either one, if the corresponding subcarrier index belongs to the set of active subcarriers, which we denote by A, or zero for the null subcarriers. The kth entry of vector is given by

$${m}_{k} = \{ \begin{matrix}1 , if k ∈ 𝔸 \\ 0 , otherwise\end{matrix} .$$

In most practical OFDM transceivers, the subcarrier in the middle of the spectrum, as well as the subcarrier at the lower edge of the band are unmodulated (null). The middle subcarrier is null to ensure a stable DC bias for the VLC transmission, whereas the first subcarrier is null due to the even FFT size (usually a power of 2).

In accordance with the invention, we generalize the idea of null subcarrier control by assuming that there are N_{middle} additional null subcarriers on each side of the middle subcarrier, N_{edge}+1 null subcarriers at the lower edge of the band and N_{edge} null subcarriers at the upper edge of the band. Therefore, the total number of active subcarriers is M=N−2(N_{middle}+N_{edge}+1)_{.}

An example of active/null subcarrier spectral mask m is illustrated in FIG. 5. It should be noted that this is a double sided representation of the baseband spectrum, such that the DC zero frequency point is in the middle. This spectrum assumes N=32 subcarriers, of which M=20 are active. There are N_{middle}=2 null subcarriers on each side of the middle subcarrier, N_{edge}+1=4 null subcarrier at the lower edge of the spectrum, and N_{edge}=3 null subcarriers at the upper edge.

Such a null subcarrier assignment is sufficiently general for most practical OFDM systems, not only VLC. For example, in WiFi (the IEEE 802.11a/g/n standard), N=64, M=52, N_{middle}=0 and N_{edge}=5. However, this particular type of spectral mask is not a strict requirement for the proposed precoder. According to embodiments, null and active subcarriers can be assigned arbitrarily, for example, to enable multi-user access.

In order to be able to ensure the desired subcarrier nulling, let us define the spectral mask matrix:

M=mm^{T}+(1_{N}−m)(1_{N}−m)^{T}

where 1_{N} is an N×1 vector of ones, and (⋅)^{T} denotes the matrix transpose. The structure of matrix M exhibits a special binary pattern which looks like a checkerboard of alternate regions of nulls and ones, as shown in FIG. 6 (dark colour represents zero entries, whereas light colour represents unit entries).

A patterned matrix, is considered to be any matrix whose zero entries exhibit the same structure as the zeros in the matrix M (shown by the dark colour), and has arbitrary entries in the other positions (in place of the unit elements in M, shown by light colour). This pattern is important because it allows the preservation of the null subcarriers, and therefore, it will be imposed on the proposed precoder. A patterned matrix may be obtained, for example, by multiplying element-wise an arbitrary square matrix by the checkerboard-like spectral mask matrix M. It should be noted that although this spectral mask and corresponding matrix show the entries as either one or zero, in some cases the non-null entries may have different values between zero and up to and including one, where spectral mask is not a substantially rectilinear shape.

Let us first define the N×N power-normalized IFFT matrix whose (k,n) entries are given by

$${\{ F \}}_{k , n} = \frac{1}{\sqrt{N}} exp ( + j \frac{2 π k}{N} n )$$

where J=\sqrt{−1} is the imaginary unit,

$$k = - \frac{N}{2} , … , \frac{N}{2} - 1$$

is the frequency-domain index, and n=0, . . . , N−1 is the time-domain index. Since the IFFT matrix is unitary, its inverse is its Hermitian transpose, i.e., the FFT matrix.

The proposed precoding matrix W is chosen to satisfy the following criteria:
1. be as close as possible in Frobenius norm to the FFT matrix, in order to produce very low PAPR (such as the FFT-precoded OFDM)
2. be unitary (like the FFT matrix), in order to avoid noise colouring, and at the same time, ensure full rank for lossless symbol recovery at the receiver (RX).
3. Be a patterned matrix in order to preserve the location of null subcarriers.

Therefore, we formulate the problem of finding the precoding matrix as a matrix optimization problem under the constraint that W is an N×N unitary patterned matrix, i.e.:

$$\begin{matrix}W = {arg { min}_{P}}_{ } \{ ‖ P - {F}^{H} ⊙ M ‖ \begin{matrix}2 \\ F\end{matrix} \} \\ subject to {W}^{H} W = {I}_{N} and W = W ⊙ M ,\end{matrix}$$

where ∥⋅∥ represents the matrix Frobenius norm, I_{N} is the N×N identity matrix, ⊙ denotes the Hadamard (elementwise) matrix product, and (⋅)^{H} is the Hermitian transpose of a matrix.

The solution to the above problem is the orthogonal projection (under the standard Euclidean metric) of the patterned matrix F^{H}⊙M onto the Lie group of N×N unitary matrices U(N). The orthogonal projection of an arbitrary matrix A onto U(N) can be obtained from its singular value decomposition A=UΣV^{H} as proj{A}=UV^{H}. Therefore, the desired precoder matrix is obtained as:

W=proj{F^{H}⊙M}

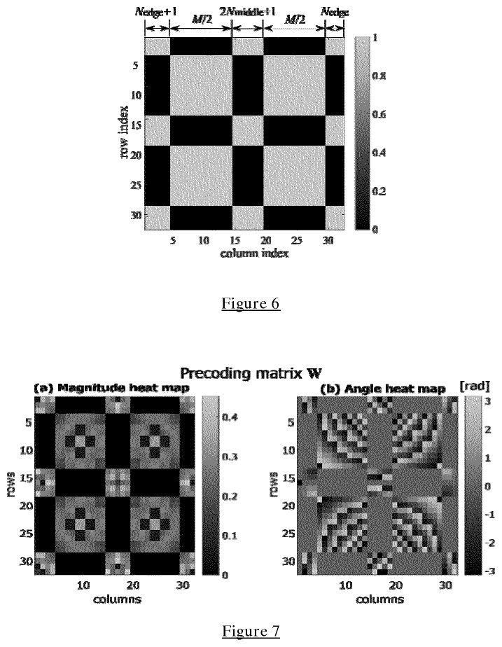

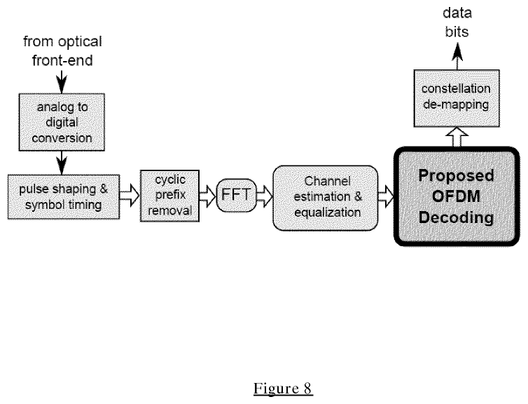

The result of this projection is a unitary patterned matrix as required. The heat map of magnitude and angle of its elements are illustrated in FIG. 7. The zero entries obey the imposed checkerboard-like pattern.

The overall processing of the horizontal part of the TX chain in FIG. 4 can be described by the following simple matrix equation:

$${s}_{k} = TFWB [ \begin{matrix}Re \{ x \} \\ Im \{ x \}\end{matrix} ]$$

where T is the (N+L)×N_{CP} addition matrix which is formed by the last L rows of I_{N} followed by I_{N} itself. B is an N×M matrix that maps the real and imaginary parts of the complex-valued vector x to the active subcarriers before precoding. B comprises only the M columns of I_{N}, namely the ones whose indices belong to the set of active subcarriers indices [symbol] .

The signals modulated in this way can be decoded in a decoder that performs the inverse operations to those performed at the coder. Thus, a Fast Fourier Transform FFT is performed on the signal, equalization may then be performed to remove errors in the signals due to channel losses, and a modified Inverse Fast Fourier Transform is then performed, the Inverse Fast Fourier Transform being modified in a corresponding way to the way that the Fast Fourier Transform was modified in the precoder.

In practice the FFT matrix is simply the Hermitian transpose of the IFFT matrix in the coder (shown in FIG. 2) with the modified IFFT matrix being simply the Hermitian transpose of the modified FFT matrix in the precoder.

FIG. 8 shows a block diagram illustrating decoding circuitry for performing these operations. A signal is received from a modulated optical source by a user, perhaps by an optical sensor on a user equipment such as a smart phone. Where the signal is a multi-user signal a predetermined subset of subcarriers relevant to that user will be monitored. The signal is converted from an analogue to a digital signal and where there is a cyclic prefix this is removed and used to compensate for channel effects. A Fast Fourier Transform is then performed which involves the signal being multiplied by the Hermitian transpose of the IFFT matrix in the coder shown in FIG. 2. Channel estimation and equalization may then be performed to compensate for multipath effects and the signal is further decoded by a modified Inverse Fast Fourier Transform operation being applied to the signal. This involves the signal being multiplied by the Hermitian transpose of the modified FFT matrix of the precoder in FIG. 2. Constellation de-mapping is then performed to retrieve the data signal.

Although both the encoding and decoding can be performed by a processor controlled by software, in preferred embodiments it is performed by hardware configured to perform these data manipulations. In this regard the computational speed required for processing the signals at the data rates that they can be transmitted by VLC means that a hardware implementation is preferred. This may be implemented in FPGA (field programmable gate arrays) or by other circuitry configured to perform these functions.

In summary, the proposed UCP-OFDM scheme possesses the following advantages:

It exhibits ultra-low PAPR, comparable to single-carrier transmissions. This is especially true for a large number of subcarriers (>256), when the PAPR gap between the proposed scheme and the state-of-the-art U-OFDM can be as large as 5 to 10 dB.

It provides full control over the null subcarriers, unlike single carrier modulation, where the DC-wandering effect degrades the performance significantly. Therefore, unlike existing SC schemes, no signal up/down-conversion is required.

It allows multi-user access in subcarrier domain.

Since the proposed precoder is a unitary matrix (hence full-rank), it preserves the noise covariance (no noise coloring takes place), and is distortionless (in absence of noise, the data symbols are recovered exactly).

The UCP-OFDM signal is real-valued provided that the input symbols are real-valued (for complex-valued constellation, real and imaginary parts are used)

It is non-redundant and data-independent, unlike other schemes that either introduce overhead, thus decreasing the data rate, or require expensive optimization to be carried out in real-time for every transmitted OFDM symbol in order to either shuffle null subcarriers, or calculate the redundant part of the symbol.

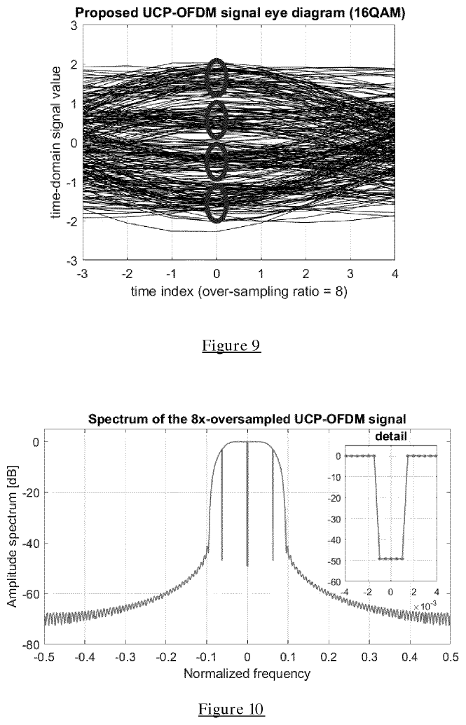

FIG. 9 shows the eye diagram of one transmitted precoded OFDM symbol. The input constellation is 16-QAM (i.e., the precoder inputs are 4-PAM bipolar real and imaginary parts). An oversampling ratio of 8 is employed, and the optimum sampling time instance corresponds to zero index on the horizontal axis.

It can be seen that the eye diagram in FIG. 9 looks very similar to the one of a single carrier SC modulation using the same type of constellation, the signal traces at the optimal sampling instance are grouped around four values corresponding to the original 4-PAM modulation (marked by the grey ellipses). When higher-order constellations are used, an approximately uniform distribution of the instantaneous signal values is achieved, like in SC modulation. This is because the proposed precoder applies a minimum alteration to the SC signal in order to obtain the arbitrary subcarrier nulling, which is not possible in SC transmission.

The amplitude spectrum of the oversampled precoded OFDM signal is shown in FIG. 10. There are five null subcarriers around zero frequency, as required by the design constraints (see the zoomed detail). A single null subcarrier at the edge of the spectrum is visible, which after oversampling, appears on both sides.

The proposed UCP-OFDM scheme provides the lowest PAPR to date, subject to full control over the null subcarriers. It also allows for multi-user access.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the Figures, including any functional blocks labelled as “processors” or “logic”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “logic” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. Processing circuitry for processing a data signal prior to transmitting said signal as a visible light communication signal, said processing circuitry comprising:
an input for receiving said data signal to be transmitted;
mapping circuitry operable to map said data signal to a set of active subcarriers and to add nulls corresponding to inactive subcarriers to generate a mapped data signal;
transforming circuitry operable to apply a modified Fourier Transform operation to said mapped data signal to generate a transformed signal, said Fourier Transform operation being modified to maintain said nulls corresponding to said inactive subcarriers in said transformed signal, said transforming circuitry being operable to apply modified coefficients to at least some data values corresponding to active subcarriers to compensate for said maintained nulls, such that said modified Fourier Transform operation does not change the overall energy of the data signal.

2. Processing circuitry according to claim 1, wherein said transforming circuitry comprises:
transforming circuitry operable to multiply said mapped data signal by a precoding matrix, said precoding matrix comprising a Fourier Transform matrix converted to form said precoding matrix, conversion of said Fourier Transform matrix comprising amending coefficients in contiguous regions determined by a location of said inactive subcarriers to nulls; and modifying values of coefficients in adjacent regions in dependence upon an original value of said coefficients amended to said null coefficients, such that a total magnitude of coefficient values of different regions in said matrix and said converted matrix is constant, thereby preserving a unitary property of said matrix.

3. Processing circuitry according to claim 2, wherein said precoding matrix is dependent upon a spectral mask applied to said data signal during said mapping, said spectral mask determining said active and said inactive subcarriers.

4. Processing circuitry according to claim 3, wherein said precoding matrix is a patterned matrix, comprising regions of null and non-null values arranged in a pattern of alternating regions, said pattern being dependent on said spectral mask.

5. Processing circuitry according to claim 2, wherein said precoding matrix comprises a matrix selected by matrix optimisation techniques to have a Frobenius norm of the difference between elements in the Fourier Transform matrix and the converted Fourier Transform matrix that is a minimum whilst maintaining a unitary property and comprising said contiguous regions of nulls.

6. Processing circuitry according to claim 1, wherein said set of inactive subcarriers comprise at least one subcarrier corresponding to zero frequency of a baseband spectrum and at least one edge of said baseband spectrum.

7. Processing circuitry according to claim 1, comprising further transforming circuitry operable to apply an inverse Fourier Transform operation to said transformed signal to generate a multi-carrier orthogonal frequency division multiplexed signal.

8. Processing circuitry according to claim 7, wherein said transforming circuitry and said further transforming circuitry are the same circuitry said modified Fourier Transform operation and said Inverse Fourier Transform operation being performed by said circuitry.

9. Processing circuitry according to claim 8, wherein said transforming circuitry is configured to multiply said mapped data signal by a combined matrix, said combined matrix being generated by multiplying said modified Fourier Transform matrix and said Inverse Fourier Transform matrix.

10. Processing circuitry according to claim 1, wherein said data signal comprises data signals received from a plurality of users, and said mapping circuitry is operable to map a data signal destined for one user to one set of active subcarriers and to map a data signal destined for at least one further user to at least one further set of active subcarriers.

11. Processing circuitry operable to process a received visible light multi-carrier orthogonal frequency division multiplexed signal, said signal comprising low amplitude portions corresponding to inactive subcarriers comprising, said processing circuitry comprising:
transforming circuitry operable to apply a Fourier Transform operation to said received signal to generate a transformed signal;
further transforming circuitry operable to apply a modified Inverse Fourier Transform operation to said transformed signal to generate a data signal, said modified inverse Fourier Transform operation converting said low amplitude portions of said received signal corresponding to said inactive subcarriers to null signals and applying modified coefficients to at least some values corresponding to active subcarriers, said modified coefficients being such that said modified Inverse Fourier Transform operation does not change an overall energy of said data signal.

12. Processing circuitry according to claim 11, wherein said further processing circuitry is configured to:
multiply said data signal by a Hermitian transpose of a precoding matrix, said precoding matrix comprising a converted Fourier Transform matrix, conversion of said Fourier Transform matrix comprising: null coefficients in contiguous regions determined by a location of said inactive subcarriers; and coefficients in adjacent regions amended such that a total magnitude of coefficient values of different regions in said matrix and said converted matrix is constant, thereby preserving a unitary property of said matrix.

13. Processing circuitry according to claim 11 comprising:
equalization circuitry arranged between said transforming and said further transforming circuitry operable to perform equalization of said received signals to compensate for different channel losses.

14. Processing circuitry according to claim 11, comprising separating circuitry configured to separate signals according to sets of subcarriers, signals from one set of subcarriers corresponding to signals from one user, and signals from at least one further set of subcarriers corresponding to signals from at least one further user.

15. A method of processing a data signal prior to transmitting said signal as a visible light communication signal, said method comprising:
receiving said data signal to be transmitted
mapping said data signal to a set of active subcarriers and adding nulls corresponding to inactive subcarriers to generate a mapped data signal;
applying a modified Fourier Transform operation to said mapped data signal to generate a transformed signal, said Fourier Transform operation being modified to maintain said nulls corresponding to said inactive subcarriers in said transformed signal, and to apply modified coefficients to at least some data values corresponding to active subcarriers to compensate for said maintained nulls, such that said modified Fourier Transform operation does not change the overall energy of the data signal.

16. A method according to claim 15, wherein said applying said modified Fourier Transform operation comprises:
multiplying said mapped data signal by a precoding matrix, said precoding matrix comprising a Fourier Transform matrix converted to form said precoding matrix, by amending coefficients in contiguous regions determined by a location of said inactive subcarriers to nulls; and modifying values of coefficients in adjacent regions in dependence upon an original value of said coefficients amended to said null coefficients, such that a total magnitude of coefficient values of different regions in said matrix and said converted matrix is constant, thereby preserving a unitary property of said matrix.

17. A method according to claim 16, wherein said precoding matrix is dependent upon a spectral mask applied to said data signal during said mapping, said spectral mask determining said active and said inactive subcarriers.

18. A method according to claim 17, wherein said precoding matrix is a patterned matrix, comprising regions of null and non-null values arranged in a pattern of alternating regions, said pattern being dependent on said spectral mask.

19. A method according to claim 16, wherein said precoding matrix comprises a matrix selected by matrix optimisation techniques to have a Frobenius norm of the difference between elements in the Fourier Transform matrix and the converted Fourier Transform matrix that is a minimum whilst maintaining a unitary property and comprising said contiguous regions of nulls.

20. A method according to claim 15, wherein said set of inactive subcarriers comprise at least one subcarrier corresponding to zero frequency of a baseband spectrum and at least one at a lower edge of said baseband spectrum.

21. A method according to claim 15, comprising a further applying an Inverse Fourier Transform operation to said transformed signal to generate a multi-carrier orthogonal frequency division multiplexed signal.

22. A method according to claim 21, wherein said applying said modified Fourier Transform operation and said further applying said Inverse Fourier Transform operation are performed as a single operation.

23. A method according to claim 22, wherein said single operation comprises multiplying said mapped data signal by a combined matrix, said combined matrix being generated by multiplying said modified Fourier Transform matrix and said inverse Fourier Transform matrix together.

24. A method according to claim 21, further comprising adding a cyclic prefix or a zero prefix to said multi-carrier orthogonal frequency division multiplexed signal.

25. A method according to claim 15, further comprising:
an initial performing serial to parallel conversion of said received data signal to form a plurality of parallel data signals;
said subsequent operations, prior to said transmitting being performed on said plurality of parallel data signals; and
prior to transmitting said visible light communication signal performing a parallel to serial conversion of said plurality of parallel signals.

26. A method according to claim 15, wherein said data signal comprises data signals received from a plurality of users, and said mapping comprises mapping a data signal destined for one user to one set of active subcarriers and mapping a data signal destined for at least one further user to at least one further set of active subcarriers.

27. A method of processing a received visible light multi-carrier orthogonal frequency division multiplexed signal, said signal comprising low amplitude portions corresponding to inactive subcarriers comprising:
applying a Fourier Transform operation to said received signal to generate a transformed signal;
applying a modified Inverse Fourier Transform operation to said transformed signal to generate a data signal, said modified Inverse Fourier Transform operation converting said low amplitude portions of said received signal corresponding to said inactive subcarriers to null signals and applying modified coefficients to at least some values corresponding to active subcarriers, said modified coefficients being such that said modified inverse Fourier Transform operation does not change an overall energy of said data signal.

28. A method according to claim 27, wherein said step of applying said modified Inverse Fourier Transform operation comprises:
multiplying said data signal by a Hermitian transpose of a precoding matrix, said precoding matrix comprising a converted Fourier Transform matrix, said converted Fourier Transform matrix comprising: null coefficients in contiguous regions determined by a location of said inactive subcarriers; and coefficients in adjacent regions amended such that a total magnitude of coefficient values of different regions in said matrix and said converted matrix is constant, thereby preserving a unitary property of said matrix.

29. A method according to claim 27 comprising:
between said applying said Fourier Transform operation and said modified Inverse Fourier Transform Operation, performing an equalization to compensate for different channel losses.

30. A method according to claim 27, comprising separating signals according to sets of subcarriers, signals from one set of subcarriers corresponding to signals from one user, and signals from at least one further set of subcarriers corresponding to signals from at least one further user.

31. A computer program which when executed by a processor is operable to control said processor to perform said method of claim 15.
